(19) United States
(12) Patent Application Publication
(10) Pub. No.: US 2024/0159881 A1
(43) Pub. Date: May 16, 2024

(54) FMCW LIDAR SIGNAL DISAMBIGUATION SAMPLING AND PROCESSING

(71) Applicant: Voyant Photonics, Inc., New York, NY (US)

(72) Inventors: Nir Regev, New York, NY (US); Christopher T. Phare, New York, NY (US)

(21) Appl. No.: 18/508,750

(22) Filed: Nov. 14, 2023

Related U.S. Application Data
(60) Provisional application No. 63/383,534, filed on Nov. 14, 2022.

(51) Int. Cl. G01S 7/4913; G01S 7/481; G01S 17/58

(52) U.S. Cl. CPC G01S 7/4913; G01S 7/4816; G01S 17/58

(57) ABSTRACT

Disclosed are systems and methods for optimizing signal sampling and processing of LIDAR FMCW return signals. Multiple sampling rates are applied to one or more up and down chirps to disambiguate the return signals over an extended beat frequency range thereby extending or improving range and velocity measurements or reducing hardware requirements.

### FIELD OF THE INVENTION

The present disclosure relates to LiDAR (Light Detection and Ranging) systems and methods, and particularly to FMCW (Frequency Modulated Continuous Wave) LiDAR signal disambiguation sampling and processing circuits and methods.

### BRIEF SUMMARY

According to a first aspect, there is provided an integrated photonics system including: a photonic integrated circuit including a photodiode (PD) for receiving a mixed optical signal including a combination of an outgoing LiDAR chirped optical signal and a returning LiDAR chirped optical signal, and generating from the mixed optical signal an electrical beat signal having a true beat frequency; at least one analog to digital converter (ADC) for sampling the electrical beat signal according to at least two predetermined sampling frequencies different from each other, and for generating respective at least two measured beat frequencies corresponding to the true beat frequency; and processing circuitry for receiving the at least two measured beat frequencies and configured to disambiguate the at least two measured beat frequencies, generating a candidate true beat frequency value.

In some embodiments, the at least one ADC samples in parallel the electrical beat signal from a single chirp segment.

In some embodiments, the at least one ADC comprises multiple ADCs, at least one for each predetermined sampling frequency, each sampling in parallel a duplicate of the electrical beat signal from the single chirp segment.

In some embodiments, the at least one ADC serially samples the electrical beat signal from separate similar chirp segments serially.

In some embodiments, the at least one ADC comprises a single ADC serially sampling multiple similar electrical beat signals from the similar chirp segments one after another, at least one similar chirp segment for each predetermined sampling frequency.

In some embodiments, the predetermined sampling frequencies have been selected such that a number of sampling points per sampling time period for each predetermined sampling frequency is a prime number unequal to the number sampling points per sampling time period for every other predetermined sampling frequency.

In some embodiments, the predetermined sampling frequencies have been selected such that a number of sampling points per sampling time period for each predetermined sampling frequency is coprime with and unequal to the number sampling points per sampling time period for every other predetermined sampling frequency.

In some embodiments, the predetermined sampling frequencies have been selected such that a number of sampling points per sampling time period for each predetermined sampling frequency has a least common multiple with the number of sampling points per sampling time period for every other predetermined sampling frequency, such that the effective measurable beat frequency range spans distance ranges and Doppler velocities of interest.

In some embodiments, the configuration of the processing circuitry to disambiguate the at least two measured beat frequencies includes configuration of the processing circuitry for: shifting each measured beat frequency of the at least two measured beat frequencies by integer multiples of their respective predetermined sampling frequencies generating shifted measured beat frequency values; and determining when the shifted measured beat frequency values coincide with each other within a selected tolerance, generating the candidate true beat frequency value.

In some embodiments, the processing circuitry is configured for generating a first true beat frequency value corresponding to a true beat frequency of an up-chirp segment, and for generating a second true beat frequency value corresponding to a true beat frequency of a down-chirp segment, and for determining a distance range and a Doppler velocity of an object of interest from the first and second true beat frequency values.

According to another aspect there is provided a method including: selecting at least two predetermined sampling frequencies different from each other; receiving a mixed optical signal including a combination of an outgoing LiDAR chirped optical signal and a returning LiDAR chirped optical signal; generating from the mixed optical signal an electrical beat signal having a true beat frequency; sampling the electrical beat signal according to the at least two predetermined sampling frequencies, generating respective at least two measured beat frequencies corresponding to the true beat frequency; and receiving the at least two measured beat frequencies and disambiguating the at least two measured beat frequencies, generating a candidate true beat frequency value.

In some embodiments, sampling the electrical beat signal comprises sampling in parallel the electrical beat signal from a single chirp segment.

In some embodiments, sampling in parallel the electrical beat signal comprises, for each predetermined frequency sampling a duplicate of the electrical beat signal from the single chirp segment with a respective ADC.

In some embodiments, sampling the electrical beat signal comprises serially sampling the electrical beat signal from separate similar chirp segments.

In some embodiments, serially sampling comprises serially sampling with a single ADC multiple similar electrical beat signals from the similar chirp segments one after another, at least one similar chirp segment for each predetermined sampling frequency

In some embodiments, the predetermined sampling frequencies are selected such that a number of sampling points per sampling time period for each predetermined sampling frequency is a prime number unequal to the number sampling points per sampling time period for every other predetermined sampling frequency.

In some embodiments, the predetermined sampling frequencies are selected such that a number of sampling points per sampling time period for each predetermined sampling frequency is coprime with and unequal to the number sampling points per sampling time period for every other predetermined sampling frequency.

In some embodiments, the predetermined sampling frequencies are selected such that a number of sampling points per sampling time period for each predetermined sampling frequency has a least common multiple with the number of sampling points per sampling time period for every other predetermined sampling frequency, such that the effective measurable beat frequency range spans distance ranges and Doppler velocities of interest.

In some embodiments, disambiguating the at least two measured beat frequencies includes: shifting each measured beat frequency of the at least two measured beat frequencies by integer multiples of their respective predetermined sampling frequencies generating shifted measured beat frequency values; and determining when the shifted measured beat frequency values coincide with each other within a selected tolerance, generating the candidate true beat frequency value.

Some embodiments further provide for generating a first true beat frequency value corresponding to a true beat frequency of an up-chirp segment, generating a second true beat frequency value corresponding to a true beat frequency of a down-chirp segment, and determining a distance range and a Doppler velocity of an object of interest from the first and second true beat frequency values.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 illustrates a triangular waveform of a typical chirped LiDAR signal.

FIG. 2 illustrates an example plot of LiDAR beat frequencies for which there is no ambiguity.

FIG. 3 illustrates an example plot of LiDAR beat frequencies for which there is ambiguity.

FIG. 4 is a schematic block diagram of a system for LiDAR beat frequency measurement according to an embodiment.

FIG. 5 illustrates parallel sampling of a beat signal in the context of triangular waveform chirped LiDAR signals.

FIG. 6 illustrates serial sampling of a beat signal in the context of triangular waveform chirped LiDAR signals.

FIG. 7 illustrates an example of LiDAR beat frequencies illustrating use of multiple sampling frequencies to determine beat frequencies outside normal measuring ranges.

FIG. 8 is a process flow diagram of a method of LiDAR beat frequency measurement according to an embodiment.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the scope of any invention defined by the appended claims.

### DETAILED DESCRIPTION

Frequency-modulated continuous-wave (FMCW) LiDAR typically utilizes a sequence of laser frequency sweeps to achieve a high signal-to-noise-ratio (SNR) signal for use in their detection and ranging operations. As its name implies, FMCW LiDAR generates a sequence of laser chirp segments for transmission and eventual reception, using frequency modulation of a tunable continuous wave laser. The sequence of chirp segments typically include linear up-chirps and down-chirps, over which the frequency of the transmitted laser signal increases or decreases respectively. The LiDAR system receives reflections of the transmitted laser signal after interacting with a target in the form of a returning signal and combines it with a copy of the outgoing optical signal to generate a mixed optical signal. The mixed optical signal is sampled and processed to determine range and velocity information about the target.

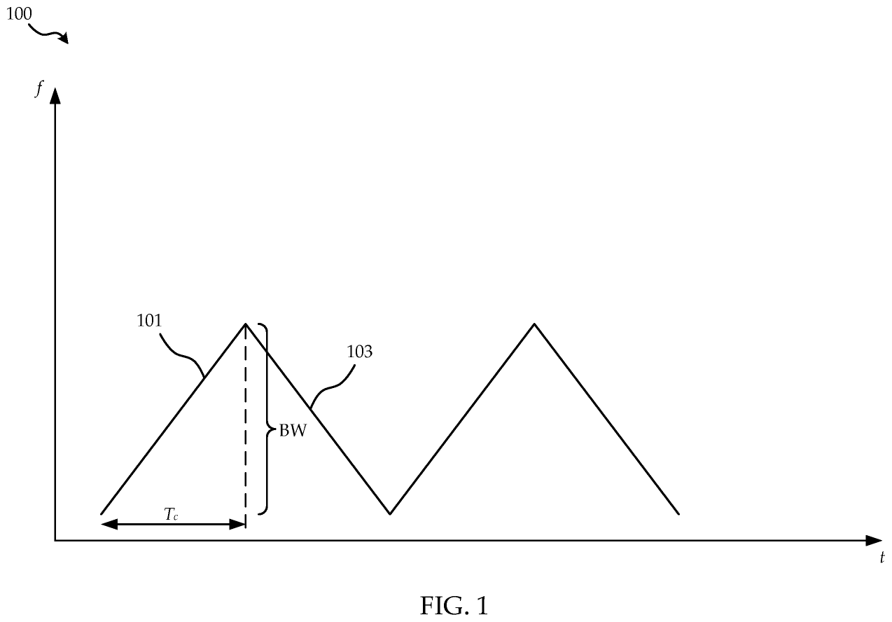

With reference to FIG. 1, a triangular waveform of a typical chirped LiDAR signal 100 will be discussed. The transmitted FMCW triangular waveform 100 is characterized by the scanned bandwidth (BW) in frequency and the chirp segment duration (T_{c}) in time, and typically consists of a repeating pattern of alternating up-chirps 101 and down-chirps 103. The returning signal which is mixed with the outgoing signal, generally has been subjected to both a delay in time, primarily a consequence of the time it takes for the transmitted signal to traverse to and from a target, and a Doppler shift in frequency, primarily due to movement of the target relative to the LiDAR system while the target reflects the signal. Once measured, the mixed optical signal, being a combination of these outgoing and returning signals, includes a beat signal which may be measured as an analog sinusoid in the time domain, its frequency (also referred to as a beat frequency) having a dependency on both the range R and the Doppler velocity V_{D}, for the up-chirps (ƒᵤₚ) and down-chirps (ƒ_{dn}) respectively, as follows:

ƒᵤₚ=[αR+βV_{D}](modƒₛ) (1)

ƒ_{dn}=[αR−βV_{D}](modƒₛ) (2)

As can be seen in equations (1) and (2) above, the beat frequencies are generally independently proportional to the range R and the Doppler velocity V_{D} of the target, and hence are effectively weighted sums of the range R and Doppler velocity V_{D}. The range, R can be determined from (1) and (2) by taking the sum of (1) and (2) and solving for R, while the Doppler velocity V_{D} can be determined from (1) and (2) by taking the difference of (1) and (2) and solving for V_{D}. It should be noted, that in equations (1) and (2), α=2BW/cT_{c}, where c is the speed of light, BW is the bandwidth of the laser chirp segment in Hz, T_{c} is the laser chirp segment duration in seconds, and β=2/λ, where λ is the wavelength in meters. It should be noted that both the α and β constant terms for the up-chirp are respectively equal to the α and β constant terms for the down-chirp in the illustrated symmetrical triangular waveform of FIG. 1, and hence also in equations (1) and (2). It should be understood that in some embodiments, the chirped laser signal may include up-chirps and down-chirps which may have different α and β constant terms, for example, the up and down chirps may have different slopes and/or different bandwidth (BW), and consequently may have different T_{c}. As can be seen from equations (1) and (2), since there are two equations with only two unknowns R and V_{D}, the constants α and β may be different for each chirp segment, while still allowing for determination of R and V_{D}.

Since these analog beat frequencies are sampled with a sampling frequency (ƒₛ), when the absolute value of the actual beat frequency exceeds |ƒₛ/2|, the measured beat frequency will be an aliased version of the true beat frequency aliased back into the available spectral range (−ƒₛ/2, +ƒₛ/2). When such a measured beat frequency is an aliased frequency the situation is referred to as “ambiguity”. The (modƒₛ) operator in equations (1) and (2) signify that when the up-chirp or down-chirp beat frequencies are greater than ƒₛ/2 or smaller than −ƒₛ/2 the measured beat frequency within the (−ƒₛ/2, +ƒₛ/2) range, will be an aliased version of the actual beat frequency lying outside of that range. Consequently, if either one (or both) of the up-chirp beat frequency ƒᵤₚ or the down-chirp beat frequency ƒ_{dn} are aliased, then the range R and Doppler velocity V_{D} determined in accordance with (1) and (2) will be incorrect. It should be understood from equations (1) and (2), that as the range R or the absolute value of the Doppler velocity V_{D} increases, the chances for one or more of the measured beat frequencies to be aliased increases. Aliasing of a negative true beat frequency less than −ƒₛ/2 forward into the (−ƒₛ/2, +ƒₛ/2) range may be referred to as positive aliasing while aliasing of a positive true beat frequency more than ƒₛ/2 back into the (−ƒₛ/2, +ƒₛ/2) range may be referred to as negative aliasing.

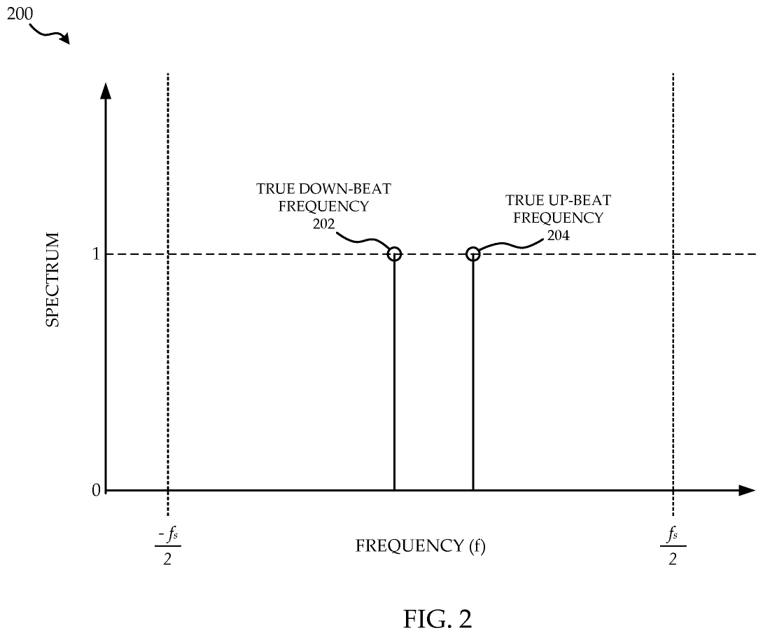

With reference now also to FIG. 2, an example plot of LiDAR beat frequencies 200 for which there is no ambiguity will be discussed. It should be noted that, for purposes of ease of illustration and interpretation, FIG. 2 is not drawn to scale.

The measured beat frequencies 200, include a measured down-beat frequency (ƒ_{dn}) corresponding to the true down-beat frequency 202, and a measured up-beat frequency (ƒᵤₚ) corresponding to the true up-beat frequency 204, because they both fall within the range of (−ƒₛ/2, +ƒₛ/2). A set of measured frequencies 200 such as that of FIG. 2 may be obtained in the context where λ=1550 nm, T_{c}=16.393 μs, BW=1.95 GHz, ƒₛ=250 MHz, V_{D}=15 m/s, and R=10 m.

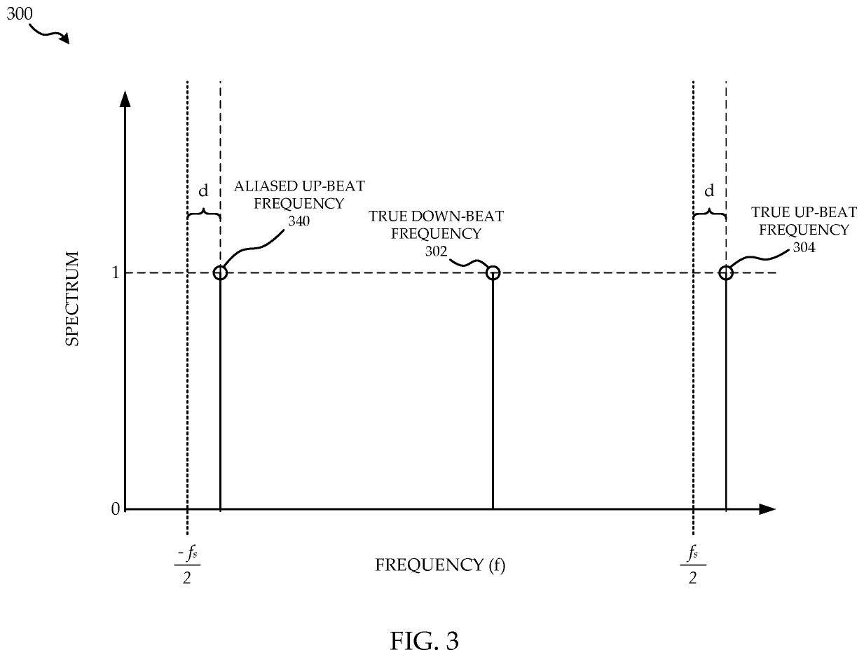

With reference now also to FIG. 3, an example plot of LiDAR beat frequencies 300 for which there is ambiguity will be discussed. It should be noted that, for purposes of ease of illustration and interpretation, FIG. 3 is not drawn to scale.

The measured beat frequencies 300, include a measured down-beat frequency (ƒ_{dn}) corresponding to the true down-beat frequency 302 because it falls within the range of (−ƒₛ/2, +ƒₛ/2), and a measured up-beat frequency (ƒᵤₚ) which is an aliased up-beat frequency 340 corresponding to a true up-beat frequency 304 which falls outside the range of (−ƒₛ/2, +ƒₛ/2). A set of measured frequencies 300 such as that of FIG. 3 may be obtained in the context where λ=1550 nm, T_{c}=16.393 μs, BW=1.95 GHz, ƒₛ=250 MHz, V_{D}=40 m/s, and R=100 m. Since aliasing back into the range of (−ƒₛ/2, +ƒₛ/2) occurs modulo ƒₛ, the amount by which the measured aliased up-beat frequency 340 is shifted from the true up-beat frequency 304 is an integer multiple of ƒₛ. This is illustrated in FIG. 3 by the true up-beat frequency 304 having the same frequency off-set d from ƒₛ/2 as the aliased up-beat frequency 340 is offset from −ƒₛ/2.

It should be noted that the fact that measurements such as the aliased measured up-beat frequency 340 occur when the absolute value of the true beat frequency exceeds |ƒₛ/2| means that the effective upper limits of the measurable range R and measurable Doppler velocity V_{D} of the target, i.e. that which may be determined with reasonable accuracy and without ambiguity, is conventionally limited to those which generate beat frequencies whose absolute value is less than |ƒₛ/2|. One way of extending these upper limits of performance is to increase the actual sampling frequency ƒₛ, however, this often requires increases in the sampling and processing circuitry which can cause implementation difficulties including, among others, increases in one or more of system costs, size, complexity, and power requirements.

In association with the embodiments disclosed herein, systems and methods of increasing performance in connection with an effective upper limit of the measurable beat frequency without ambiguity are described. The solutions presented mitigate one or more the incremental difficulties to implement the improvements in performance, and may be manifested as increased performance, reduction in implementation requirements, or both.

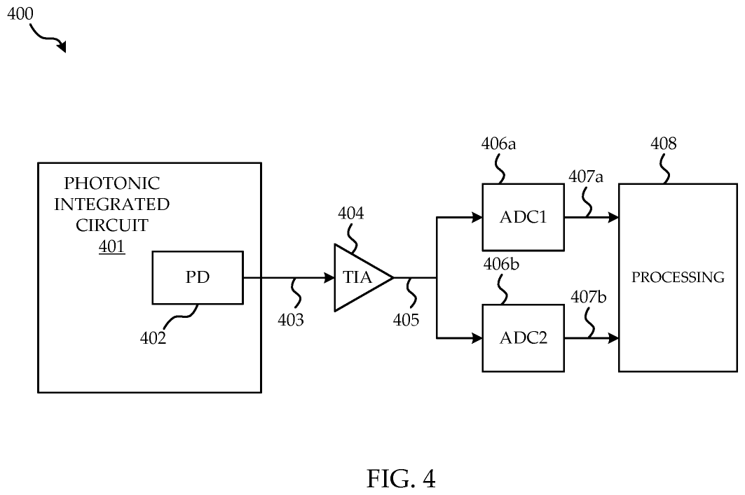

With reference now also to FIG. 4, a system for LiDAR beat frequency measurement 400 will be discussed. The system for LiDAR beat frequency measurement 400 includes a photonic integrated circuit 401 including a photodetector (PD) 402 which is fed the mixed optical signal (not shown) which contain beats. The PD 402 is coupled to a transimpedance amplifier (TIA) 404 which is coupled to first and second analog-to-digital converters ADC1 ADC2 406a 406b, each of which are coupled to processing 408. The PD 402 converts the mixed optical signal into an electrical analog signal 403 which is the beat signal. This beat signal is fed into the TIA 404 which amplifies the analog signal 403 into an electrical signal 405 which is usable by the first and second ADCs. The ADCs, each using their own unique sampling frequency, processes the beat signal 405 from the TIA 404 and outputs respective digital representations of the beat signal 407a 407b for processing by processing 408. Although FIG. 4 depicts only two parallel sampling paths through two ADCs, it should be understood that more than two sampling paths, frequencies, and ADCs may also be implemented.

In the embodiment of FIG. 4, the first ADC 406a samples the beat signal 405 with a first sampling frequency ƒₛ₁ while the second ADC 406b samples the beat signal 405 with a second sampling frequency ƒₛ₂ different from the first sampling frequency. As will be described in more detail below, the first and second sampling frequencies ƒₛ₁ ƒₛ₂ are chosen to have a specific kind of relationship between them.

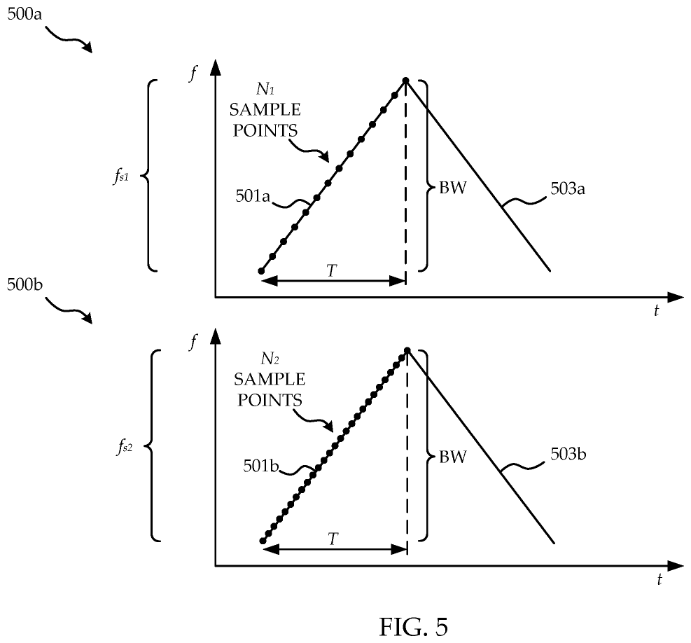

With reference to FIG. 5, parallel sampling of a beat signal in the context of triangular waveform chirped LiDAR signals will be discussed. Superimposed on the transmitted FMCW triangular waveforms are illustrations of the sampling points in time, as sampled 500a 500b by the first and second ADCs respectively. Both ADCs receive the same beat signal and therefore sample the same signal during the same up-chirps 501a 501b, and the same down-chirps 503a 503b, but due to the differing first and second sampling frequencies ƒₛ₁ ƒₛ₂ applied on the different paths through the different ADCs, each chirp segment is sampled with differing numbers of points per unit time. For example, the ADCs sample the beat signal over a common sampling time period T (depicted in FIG. 5 as roughly equal to but slightly less than the chirp segment duration T_{c}), with a differing number of points, e.g. respectively N₁ and N₂.

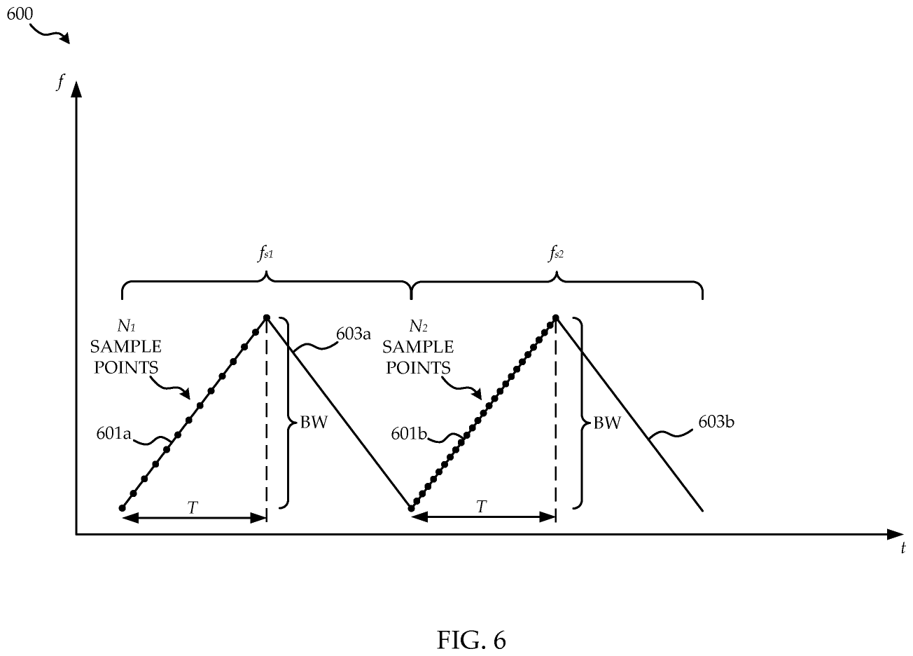

In alternatives to the embodiment illustrated in FIGS. 4 and 5, serial sampling which need not utilize more than one ADC may be utilized. In such embodiments, the chirp segments are repeated and sampled using different sampling frequencies such as that illustrated in FIG. 6.

In FIG. 6, serial sampling 600 of a beat signal in the context of triangular waveform chirped LiDAR signals is illustrated. Superimposed on the transmitted FMCW triangular waveforms are sampling points in time, sampled by at least one ADC, over a first up-chirp 601a and a second up-chirp 601b. Although the first up-chirp 601a and the second up-chirp 601b, are the same, as are the first down-chirp 603a and the second down-chirp 603b, due to the differing first and second sampling frequencies ƒₛ₁ ƒₛ₂ applied on each chirp segment, each chirp segment is sampled with a differing number of points per unit time. For example, over a first and a second sampling time period of the same duration T, the at least one ADC samples a differing number of points, e,g, respectively N₁ and N₂. It should be noted that the relationship between the sampling frequencies herein described is independent of the duration over which the chirp segments are sampled, and as such N₁ and N₂ are only used to determine and define ƒₛ₁ ƒₛ₂ and their relationship. Accordingly, N₁ and N₂ may be defined for any concrete predetermined period of time over which respectively N₁ and N₂ points are sampled, for example, the sampling time period T. Since a greater amount of time used to sample the beat signal translates into a higher signal-to-noise ratio, the chosen sampling time period T is illustrated in FIG. 6 as slightly less than T_{c}.

In some embodiments, the use of two different frequencies is provided as an optional mode of operation. In such embodiments, while in the optional mode of operation, the time duration used for two triangular waveforms (including two up-chirps and two down-chirps as illustrated in FIG. 6) are squeezed into the same duration of time normally used for a single triangular waveform (including a single up-chirp segment and a single down-chirp segment) while operating in a normal mode of operation.

Although FIGS. 5 and 6 depict only two different sampling frequencies, it should be understood that whether sampling is performed in serial or in parallel, more than two different sampling frequencies may be used ƒₛ₁, . . . , ƒₛₙ. Although sampling points have only been explicitly shown in FIGS. 5 and 6 along the up-chirp segment, it is to be understood that the same applies to the down-chirp segments, which are sampled similarly to determine the down-chirp beat frequency. Moreover, it should be understood that the systems and methods which follow are as independently and equally applicable to sampling and processing up-chirps and up-chirp beat frequencies as they are to sampling and processing down-chirps and down-chirp beat frequencies.

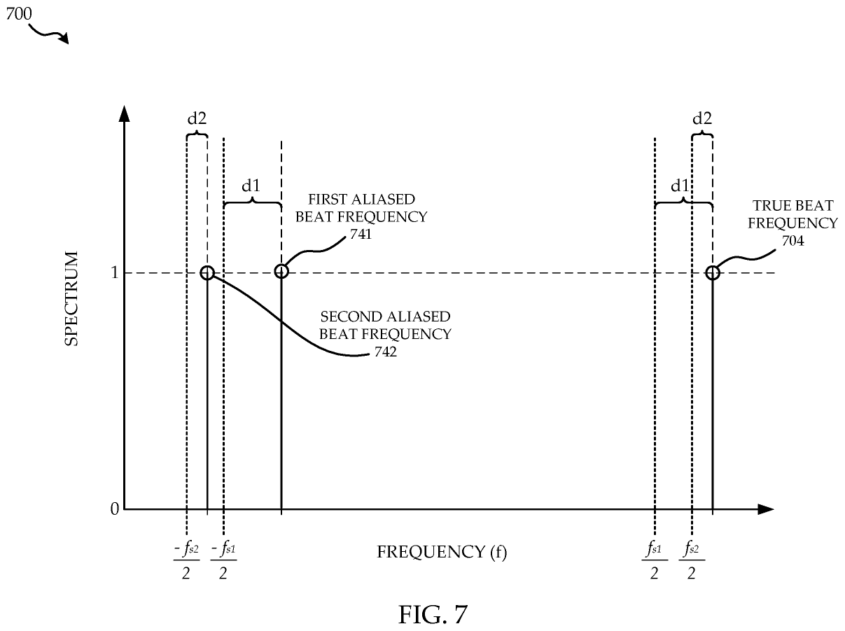

With reference to FIG. 7, an example plot of LiDAR beat frequencies 700 illustrating how multiple sampling frequencies may be utilized to determine beat frequencies outside the normal measuring ranges of those sampling frequencies.

The beat frequencies 700, include a true beat frequency 704 which is greater than the normal upper limits of the measuring ranges for both sampling frequencies, namely, both ƒₛ₁/2 and ƒₛ₂/2. Consequently, sampling with the first sampling frequency generates a first measured beat frequency 741 which is a first aliased beat frequency corresponding to the true beat frequency 704, because it falls outside the range of (−ƒₛ₁/2, +ƒₛ₁/2), while sampling with the second sampling frequency generates a second measured beat frequency 742 which is a second aliased beat frequency corresponding to the true beat frequency 704, because it falls outside the range of (−ƒₛ₂/2, +ƒₛ₂/2). A set of true and measured frequencies 700 such as that of FIG. 7 may be obtained in the context where λ=1550 nm, T_{c}=8.2 μs, BW=1.95 GHz, N₁=1021, N₂=1117, ƒₛ₁=124.56 MHz, ƒₛ₂=136.27 MHz, V_{D}=40 m/s, and R=100 m. Since aliasing back into the range of (−ƒₛ₁/2, +ƒₛ₁/2) occurs modulo ƒₛ₁ and aliasing back into the range of (−ƒₛ₂/2, +ƒₛ₂/2) occurs modulo ƒₛ₂, the amount by which the measured aliased beat frequencies 741 742 are shifted from the true beat frequency 704 are integer multiples of ƒₛ₁ and ƒₛ₂ respectively. This is illustrated in FIG. 7 by the true beat frequency 704 having the same frequency offset d1 from ƒₛ₁/2 as the first aliased beat frequency 741 is offset from −ƒₛ₁/2 and by the true beat frequency 704 having the same frequency offset d2 from ƒₛ₂/2 as the second aliased beat frequency 742 is offset from −ƒₛ₂/2.

Generating two staggered i.e. different measured beat frequencies 741 742 in the process of measuring a single beat frequency, logically implies that one or more of the measured beat frequencies 741 742 is aliased and hence there is ambiguity as to what the true beat frequency is. Consequently, one or more of the measured beat frequencies 741 742 has been shifted by a respective integer multiple of the respective sampling frequencies. To determine the true beat frequency 704 and eliminate the ambiguity, the first aliased beat frequency 741 is shifted by various integer multiples of ƒₛ₁ (including zero, positive, and negative integers) and the second aliased beat frequency 742 is shifted by various integer multiples of ƒₛ₂ (including zero, positive, and negative integers) until the values are equal. For example, adding ƒₛ₁ to the first aliased beat frequency 741 and adding ƒₛ₂ to the second aliased beat frequency 742 results in the same frequency, which is the true beat frequency 704. This process of eliminating ambiguity is also be referred to as disambiguation or de-aliasing.

It should be noted, in cases where the measured beat frequencies using different sampling frequencies already equal one another, it is assumed that no aliasing has occurred and the true beat frequency has been measured. This occurs when the true beat frequency falls within (−ƒₛ₁/2, +ƒₛ₁/2) and (−ƒₛ₂/2, +ƒₛ₂/2), but also can occur when the true beat frequency falls outside of these ranges as described further below.

Although the example of the process of de-aliasing depicted in FIG. 7 involves only a pair of sampling frequencies, and hence at most only two aliased beat frequencies, it is to be understood that the same process applies to the case of more than two sampling frequencies. In such embodiments, the true beat frequency is determined from applying the same process for each respective sampling frequency, i.e. shifting each measured beat frequency by integer multiples of the respective sampling frequencies in order to find a common resulting frequency for all of them.

Although FIG. 7 depicts only a true and aliased beat frequency associated with sampling and measurement of up-chirps, it should be understood that the same process of sampling and shifting to determine the true down-beat frequency is utilized for the down-chirp segments. Once both the up-beat frequencies and the down-beat frequencies have been de-aliased, i.e. candidate true up-beat and down-beat frequencies have been determined, they are used to estimate the range R and Doppler velocity V_{D} according to equations (1) and (2).

In order to enable the effective extension of measurement of beat frequencies beyond the ranges of (−ƒₛ₁/2, +ƒₛ₁/2) and (−ƒₛ₂/2, +ƒₛ₂/2) without aliasing or ambiguity, the two sampling frequencies should be judiciously chosen. Generally speaking, the mathematical relationship between the values of the sampling frequencies and equivalently the number of sampling points per period of time e.g. per chirp, determine the effective extension of the measurable beat frequency range using the above process. For example, choosing sampling frequencies such that 2*ƒₛ₁=3*ƒₛ₂(3*N₁=2*N₂) allows an extension of the measurable frequencies only up to a range of frequencies somewhere below 2*ƒₛ₁=3*ƒₛ₂. As noted above, true beat frequencies outside of the normal measurable ranges are aliased back by a shift equal to integer multiples of the respective sampling frequency, hence, a true beat frequency which is equal to 2*ƒₛ₁=3*ƒₛ₂ is shifted back by 3*ƒₛ₂ when sampled with ƒₛ₂ and will also be shifted back by 2*ƒₛ₁ when sampled with ƒₛ₁, but since these shifts are equal and both being applied to the same true beat frequency, the measured beat frequencies will be the same, resulting in the erroneous assumption that there is no aliasing. Since this kind of coinciding of frequency values occurs for a range of ƒₛ₂ (the smaller frequency range) about the frequency 2*ƒₛ₁=3*ƒₛ₂, the range of measurable beat frequencies has been extended only up to 3*ƒₛ₂−ƒₛ₂/2=2.5 ƒₛ₂, and equally extended negatively to −2.5 ƒₛ₂. It should be noted that just as for known methods true beat frequencies outside of a measurable frequency range are aliased back to the normal range, so too in the de-aliasing process, true beat frequencies outside of an effectively extended frequency range will be aliased back to that extended range, in the sense that multiple higher beat frequencies will give rise to the same set of staggered aliased beat frequencies. Although effective extension of the range of measurable beat frequencies does not constitute absolute de-aliasing for every theoretically possible beat frequency, it does provide improved effective disambiguation of measurable beat frequencies which are generated by objects having ranges and Doppler velocities of interest. Considering this example, it should be understood that better relationships between ƒₛ₁ and ƒₛ₂ and equivalently N₁ and N₂ may be found to extend the effective measurable beat frequency range.

Given that the sampling time period T used to define the relationship between the frequencies is common, and since T=N₁/ƒₛ₁=N₂/ƒₛ₂, the relationship between the sampling frequencies and number of sample points is N₁*ƒₛ₂=N₂*ƒₛ₁. It follows that any actual beat frequency ƒ_{beat}=N₁*ƒₛ₂=N₂*ƒₛ₁ will be aliased back to the middle of the (−ƒₛ₁/2, +ƒₛ₁/ 2) or (−ƒₛ₂/2, +ƒₛ₂/2) ranges, and for a range of the smaller of either ƒₛ₁ or ƒₛ₂ about N₁*ƒₛ₂=N₂*ƒₛ₁ the measured beat frequencies will be the same. This sets at least one upper limit for the extended effective measurement frequency range (using only two sampling frequencies) and is ±(Fₗ−ƒₛₓ/2), where F1 is N₁*ƒₛ₂=N₂*ƒₛ₁ and ƒₛₓ is the lesser of ƒₛ₁ and ƒₛ₂. Although this limit is generally applicable, it should be remembered that as in the example above, e.g. 3*N₁=2*N₂, the effective frequency measurement range only extends less (something on the order of 2.5*ƒₛ₂) than this limit no matter how large N₁ and N₂ actually are (each on the order of a thousand in the example contexts). Such an extension (to only 2.5*ƒₛ₂) would far less than the actual potential extension which may be obtained with differently selected frequencies.

In some embodiments, N₁ and N₂ are both selected specifically to be prime numbers. In such a case there will not be any m<N₁ and n<N₂ which satisfies n*ƒₛ₁=m*ƒₛ₂. Since this is equivalent to there not being any m<N₁ and n<N₂ which satisfies n*N₁=m*N₂, the least common multiple (LCM) of N₁ and N₂ is their product N₁*N₂. Consequently, there will be no exact ambiguities for all frequencies up to the limit described above, namely ±(Fₗ−ƒₛₓ/2), where F1 is N₁*ƒₛ₂=N₂*ƒₛ₁ and ƒₛₓ is the lesser of ƒₛ₁ and ƒₛ₂. Theoretically then, since typical N₁ and N₂ are on the order of a thousand, the range of effective measurable beat frequencies may be extended by on the order of multiples of thousands. In practice, since measurements of beat frequency are always only to within certain threshold margins of error, additional considerations as to which primes are selected should be made. Although not necessarily applicable to the given example contexts, if hypothetically N₁=2003 and N₂=3001, or N₁=19997 and N₂=30011 (all of which are prime numbers), then strictly speaking there will be no exact coincidence in aliased beat frequencies until true beat frequencies just below F₁=N₁*ƒₛ₂=N₂*ƒₛ₁. It should be noted however, that due to the prime numbers themselves having a ratio which is close to ⅔, the aliased beat frequencies will repeatedly come very close to coincidence. Since T=N₁*ƒₛ₂=N₂*ƒₛ₁, it follows that 2003*ƒₛ₂=3001*ƒₛ₁ which implies 2*ƒₛ₂≈3*ƒₛ₁, and hence periodically for any true frequency being an integer multiple of 3*ƒₛ₁, and 2*ƒₛ₂, the aliased beat frequencies will come close to each other. The ratio 2003/3001 differs from ⅔ only on the order of 0.1% while the ratio of 19997/30011 differs from ⅔ only on the order of 0.01%. As such, the two prime numbers should be chosen so that their resulting sampling frequencies do not give rise to different aliased beat frequencies which are too close to one another to distinguish.

It should be understood that in embodiments involving more than two sampling frequencies and hence more than two different numbers of samples N per sampling time period T, each number Nₓ may be chosen to be a prime number, also satisfying to the extent possible the condition that the resulting sampling frequencies do not give rise to indistinguishable aliased beat frequencies of true beat frequencies within the theoretical extended measurable frequency range. It should be noted that for multiple frequencies, multiple pairwise limits dictate pairwise ambiguity as between them as discussed above, however, the upper limit dictated by complete ambiguity only occurs when integer multiples of all frequencies coincide. For example, with three sampling rates, given that the sampling time period T used to define the relationships between the frequencies is common, and since T=N₁/ƒₛ₁=N₂/ƒₛ₂=N₃/ƒₛ₃ and hence 1/T=ƒₛ₁/N₁=ƒₛ₂/N₂=ƒₛ₃/N₃, one relationship between the sampling frequencies and number of sample points is ƒₛ₂*N₂*N₃=ƒₛ₂*N₁*N₃=ƒₛ₃*N₁*N₂. In a case where a true beat frequency is equal to ƒₛ₁*N₂*N₃=ƒₛ₂*N₁*N₃=ƒₛ₃*N₁*N₂ it will be aliased back by shifts of N₂*N₃ integer multiples of ƒₛ₁ which is equivalent to N₁*N₃ integer multiples of ƒₛ₂ and also to N₁*N₂ integer multiples of ƒₛ₃.

In some embodiments, the number of sample points sampling time period T are chosen to be pairwise coprime (sharing no common factors). In such embodiments, although N₁ and N₂ are not necessarily prime, they share no common factors. For example, although not necessarily applicable to given example contexts, if hypothetically N₁=255=3*5*17 and N₂=256=2⁸ there will not be any m<N₁ and m<N₂ which satisfies n*ƒₛ₁=m*ƒₛ₂. Since this is equivalent to there not being any m<N₁ and n<N₂ which satisfies n*N₁=m*N₂, the least common multiple (LCM) of N₁ and N₂ is their product N₁*N₂. Consequently, there will be no exact ambiguities for all frequencies up to the limit described above, namely ±(Fₗ−ƒₛₓ/2), where F1 is N₁*ƒₛ₂=N₂*ƒₛ₁ and ƒₛₓ is the lesser of ƒₛ₁ and ƒₛ₂. Theoretically then, since typical N₁ and N₂ are normally on the order of a thousand, the range of effective measurable beat frequencies may be extended by multiples on the order of thousands. In practice, since measurements of beat frequency are always only to within certain threshold margins of error, additional considerations as to which coprimes are chosen should be made. As was discussed with the case for prime numbers, although pairs of coprime sample points N₁ and N₂ will not give rise to exact coincidence in aliased beat frequencies until true beat frequencies just below F₁=N₁*ƒₛ₂=N₂*ƒₛ₁, the two coprime numbers should be chosen so that their resulting sampling frequencies do not give rise to different aliased beat frequencies which are too close to one another to distinguish. It should be understood that in embodiments involving more than two sampling frequencies and hence more than two different numbers of samples N per common sampling time period T, each number N, may be chosen to be pairwise coprime, also satisfying to the extent possible the condition that the resulting sampling frequencies do not give rise to indistinguishable aliased beat frequencies of true beat frequencies within the theoretical extended measurable frequency range. It should be noted that for multiple frequencies, multiple pairwise limits dictate pairwise ambiguity as discussed above, however, the upper limit dictated by complete ambiguity only occurs when integer multiples of all frequencies coincide.

It should be noted that in some embodiments, the various numbers of sampling points are all chosen to be coprimes rather than primes to facilitate ease of implementation with a clock generator PLL.

In some embodiments, the numbers of sample points per sampling time period T are chosen so that their LCM is large enough to ensure extension of the effective measurable beat frequency range to cover the desired frequency range, i.e. to enable measurement without ambiguity of the range and Doppler velocity of targets of interest, but are not themselves primes or coprimes. In such cases the LCM is smaller than the product of numbers of sample points by a factor of the product of their common factors c. For example if N₁ and N₂ share common factors whose product is c, and there are no other common factors (other than 1), each may be rewritten as N₁=c*U₁, and N₂=c*U₂, where U₁ and U₂ are the factors which multiplied by c obtain N₁ and N₂ respectively. It should be noted that since N₁ and N₂ share no other common factors than those in c, U₁ and U₂ are coprime or themselves prime numbers. In such a case, it follows from N₁*ƒₛ₂=N₂*ƒₛ₁ that c*U₁*ƒₛ₂=c*U₂*ƒₛ₁, hence U₁*ƒₛ₂=U₂*ƒₛ₁ and U₁<N₁ and U₂<N₂, therefore, there are m<N₁ and n<N₂ which satisfies n*ƒₛ₁=m*ƒₛ₂, specifically the factors U₁ and U₂. Consequently, there will be no exact ambiguities for all frequencies only up to a limit of ±(Fₗ−ƒₛₓ/2) where F1 is u₁*ƒₛ₂=U₂*ƒₛ₁ and ƒₛₓ is the lesser of ƒₛ₁ and ƒₛ₂. It follows then, that the range of effective measurable beat frequencies extends proportionally to these U factors, and hence N₁ and N₂ should be chosen for increasing U₁ and U₂, as much as possible. Since N₁=c*U₁, and N₂=c*U₂ it follows that U₂*N₁=U₁*N₂., and since U_{1 -}and U₂ are coprime, it also follows that the LCM of N₁ and N₂ is precisely U₂*N₁=U₁*N₂, and therefore, increasing U₁ and U₂, as much as possible is equivalent to increasing the LCM of N₁ and N₂ as much as possible. It also follows that, LCM=N₁*U₂=N₁*N₂/c.

In practice, since measurements of beat frequency are always only to within certain threshold margins of error, additional considerations as to which uncommon factors are chosen should be made. As was discussed with the case for prime and coprime numbers, although pairs of sample points N₁ and N₂ with respective factors U₁ and U₂ will not give rise to exact coincidence in aliased beat frequencies until true beat frequencies just below F₁=U₁*ƒₛ₂=U₂*ƒₛ₁, the two numbers should be chosen so that their resulting sampling frequencies do not give rise to indistinguishable different aliased beat frequencies of true beat frequencies within the theoretical extended measurable frequency range. It should be understood that in embodiments involving more than two sampling frequencies and hence more than two different numbers of samples N per sampling time period T, each number Nₓ may be chosen to satisfy to the extent possible the condition that the resulting sampling frequencies do not give rise to indistinguishable different aliased beat frequencies of true beat frequencies within the theoretical extended measurable frequency range. It should be noted that for multiple frequencies, multiple pairwise limits dictate pairwise ambiguity as discussed above, however, complete ambiguity only occurs when integer multiples of all frequencies coincide. For example, with three sampling rates, given that the sampling time period T used to define the relationships between the frequencies is common, and since T=N₁/ƒₛ₁=N₂/ƒₛ₂=N₃/ƒₛ₃ and hence 1/T=ƒₛ₁/N₁=ƒₛ₂/N₂=ƒₛ₃/N₃, one relationship between the sampling frequencies and number of sample points is ƒₛ₂*N₂*N₃=ƒₛ₂*N₁*N₃=ƒₛ₃*N₁*N₂. Since Nₓ=cUₓ, in a case where a true beat frequency is equal to ƒₛ₁*U₂*U₃=ƒₛ₂*U₁*U₃=ƒₛ₃*U₁*U₂ it will be aliased back by shifts of U₂*U₃ integer multiples of ƒₛ₁ which is equivalent to U₁*U₃ integer multiples of ƒₛ₂ and also to U₁*U₂ integer multiples of ƒₛ₃. With respect to a general case for m sampling frequencies, since there is a common sampling time period T: ƒₛ₁/N₁=ƒₛ₂/N₂= . . . =ƒₛₘ/Nₘ. Since Nₖ may be rewritten as: Nₖ=cUₖ where c are the common factors of all of N₁, N₂, . . . Nₘ, it follows that ƒₛ₁/U₁=ƒₛ₂/U₂= . . . =ƒₛₘ/Uₘ. Multiplying by a product of all Uₖ, namely: Πₖ₌₁^{m}Uₖ, we obtain:

$${f}_{s 1} {\prod }_{k = 2}^{m} {U}_{k} = {f}_{s 2} {{\prod }_{k = 1}^{m}}_{k \neq 2} {U}_{k} = … = {f}_{s m} {\prod }_{k = 1}^{m - 1} {U}_{k}$$

Letting ƒₛⱼ be the lowest sampling frequency, the theoretical upper and lower limits are:

$$\pm ( {f}_{s j} {{\prod }_{k = 1}^{m}}_{k \neq j} {U}_{k} - \frac{{f}_{sj}}{2} )$$

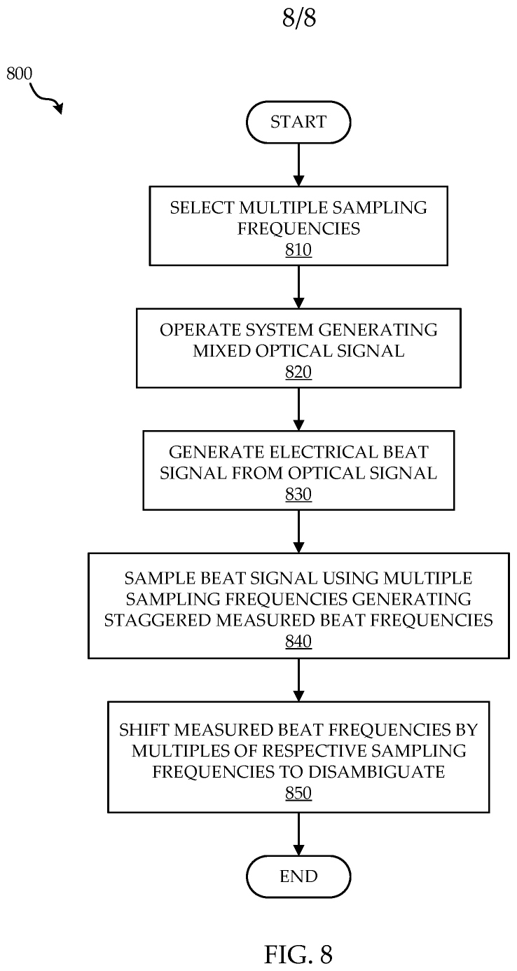

Referring also to FIG. 8 a method of LiDAR beat frequency measurement 800 will now be discussed.

The process begins with selecting a plurality of sampling frequencies 810 such as ƒₛ₁ and ƒₛ₂. As described above the frequencies may correspond to particular numbers of sampling points per sampling time period T, which may for example each be prime numbers, coprime with each other, or otherwise being neither and yet having been chosen to have large U factors or equivalently to have a sufficiently large least common multiple (LCM). Furthermore, the frequencies are chosen to help ensure distinguishable aliased beat frequencies for true beat frequencies within the target extended measurable beat frequency range. The LiDAR system is operated to transmit a triangular chirped optical signal which encounters a target, is reflected back to the LiDAR system and combined with a copy of the outgoing signal generating a mixed optical signal 820. The mixed optical signal is received and converted into an electrical beat signal 830 for example, by a PD and TIA. Either in series or in parallel, using for example one or more ADCs, the beat signal is sampled using the multiple sampling frequencies over each chirp segment of interest (up-chirp and down-chirp) generating the staggered measured beat frequencies 840 (when aliased) per type of chirp. Measured beat frequencies of each sampling frequency are shifted by integer multiples of the respective sampling frequencies and compared to determine if they match within tolerances, thereby disambiguating the beat frequencies i.e. determining the true beat frequency 850.

An example fragment of source code for determining a true beat frequency from two measured beat frequencies follows below. It should be understood that the following is provided only as one example of implementing the above procedures.

```
function f_beat_est = disambiguate_staggered_chirps(f_beat_1,
f_beat_2, wf1, wf2)
%% de-alias left and right up to 10x sampling rate
f_beat_1_sol_pos_alias = f_beat_1 − (0:10) * wf1.fs;
f_beat_2_sol_pos_alias = f_beat_2 − (0:10) * wf2.fs;
f_beat_1_sol_neg_alias = f_beat_1 + (0:10) * wf1.fs;
f_beat_2_sol_neg_alias = f_beat_2 + (0:10) * wf2.fs;
%% define tolerance to say “beat freqs aligned”
tol = 1000;
diff_pos_alias = abs(f_beat_1_sol_pos_alias −
f_beat_2_sol_pos_alias);
diff_neg_alias = abs(f_beat_1_sol_neg_alias −
f_beat_2_sol_neg_alias);
ind_pos_alias = find(diff_pos_alias < tol);
ind_neg_alias = find(diff_neg_alias < tol);
%% de-alias to true beat freq
if ind_pos_alias
  f_beat_est = f_beat_1 − (ind_pos_alias-1) * wf1.fs;
elseif ind_neg_alias
  f_beat_est = f_beat_1 + (ind_neg_alias-1) * wf1.fs;
end
```

It is to be understood, that the component parts of the LiDAR system and the LiDAR beat frequency measurement system 400 with which it cooperates, may operate as part of a single instrument or device or may operate as part of a multiplicity of interconnected devices working together in proximity or remotely, or any combination thereof.

The above described beat frequency measurement process 800 may be performed by a processing device 408 such as a micro-processor/FPGA or any one or more other similar device, which may be implemented using one or more application specific integrated circuits (ASIC), micro-controllers, general purpose computer systems, digital signal processors, programmable logic devices (PLD), field programmable logic devices (FPLD), and the like, programmed according to the teachings as illustrated and described herein, as will be appreciated by those skilled in the optical, networking, software, and computing arts.

In addition, two or more computing systems or devices may be substituted for any one of the processors or controllers described herein. Accordingly, principles and advantages of distributed processing, such as redundancy, replication, and the like, also can be implemented, as desired, to increase the robustness and performance of processors or controllers described herein.

The operation of the example beat frequency measurement methods may be performed by machine readable instructions. In these examples, the machine readable instructions comprise an algorithm for execution by: (a) a processor, (b) a controller, and/or (c) one or more other suitable processing device(s). The algorithm may be embodied in software stored on tangible media such as, for example, a flash memory, a CD-ROM, a floppy disk, a hard drive, a digital video (versatile) disk (DVD), or other memory devices, but persons of ordinary skill in the art will readily appreciate that the entire algorithm and/or parts thereof could alternatively be executed by a device other than a processor and/or embodied in firmware or dedicated hardware in a well-known manner (e.g., it may be implemented by an application specific integrated circuit (ASIC), a programmable logic device (PLD), a field programmable logic device (FPLD), discrete logic, etc.). For example, any or all of the component processes or steps of the beat frequency measurement methods could be implemented by software, hardware, and/or firmware. Also, some or all of the machine readable instructions represented may be implemented manually.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the scope of an invention as defined in the appended claims.

What is claimed is:

1. An integrated photonics system comprising:
a photonic integrated circuit including a photodiode (PD) for receiving a mixed optical signal comprising a combination of an outgoing LiDAR chirped optical signal and a returning LiDAR chirped optical signal, and generating from the mixed optical signal an electrical beat signal having a true beat frequency;
at least one analog to digital converter (ADC) for sampling the electrical beat signal according to at least two predetermined sampling frequencies different from each other, and for generating respective at least two measured beat frequencies corresponding to the true beat frequency; and
processing circuitry for receiving said at least two measured beat frequencies and configured to disambiguate the at least two measured beat frequencies, generating a candidate true beat frequency value.

2. The integrated photonics system of claim 1, wherein the at least one ADC samples in parallel the electrical beat signal from a single chirp segment.

3. The integrated photonics system of claim 2, wherein the at least one ADC comprises multiple ADCs, at least one for each predetermined sampling frequency, each sampling in parallel a duplicate of the electrical beat signal from the single chirp segment.

4. The integrated photonics system of claim 1, wherein the at least one ADC serially samples the electrical beat signal from separate similar chirp segments.

5. The integrated photonics system of claim 4, wherein the at least one ADC comprises a single ADC serially sampling multiple similar electrical beat signals from said similar chirp segments one after another, at least one similar chirp segment for each predetermined sampling frequency.

6. The integrated photonics system of claim 1, wherein the predetermined sampling frequencies have been selected such that a number of sampling points per sampling time period for each predetermined sampling frequency is a prime number unequal to the number sampling points per sampling time period for every other predetermined sampling frequency.

7. The integrated photonics system of claim 1, wherein the predetermined sampling frequencies have been selected such that a number of sampling points per sampling time period for each predetermined sampling frequency is coprime with and unequal to the number sampling points per sampling time period for every other predetermined sampling frequency.

8. The integrated photonics system of claim 1, wherein the predetermined sampling frequencies have been selected such that a number of sampling points per sampling time period for each predetermined sampling frequency has a least common multiple with the number of sampling points per sampling time period for every other predetermined sampling frequency, such that the effective measurable beat frequency range spans distance ranges and Doppler velocities of interest.

9. The integrated photonics system of claim 1, wherein the configuration of the processing circuitry to disambiguate the at least two measured beat frequencies includes configuration of the processing circuitry for:
shifting each measured beat frequency of the at least two measured beat frequencies by integer multiples of their respective predetermined sampling frequencies generating shifted measured beat frequency values; and
determining when the shifted measured beat frequency values coincide with each other within a selected tolerance, generating said candidate true beat frequency value.

10. The integrated photonics systems of claim 9, wherein the processing circuitry is configured for generating a first true beat frequency value corresponding to a true beat frequency of an up-chirp segment, and for generating a second true beat frequency value corresponding to a true beat frequency of a down-chirp segment, and for determining a distance range and a Doppler velocity of an object of interest from the first and second true beat frequency values.

11. A method comprising:
selecting at least two predetermined sampling frequencies different from each other;
receiving a mixed optical signal comprising a combination of an outgoing LiDAR chirped optical signal and a returning LiDAR chirped optical signal;
generating from the mixed optical signal an electrical beat signal having a true beat frequency;
sampling the electrical beat signal according to the at least two predetermined sampling frequencies, generating respective at least two measured beat frequencies corresponding to the true beat frequency; and
receiving said at least two measured beat frequencies and disambiguating the at least two measured beat frequencies, generating a candidate true beat frequency value.

12. The method of claim 11, wherein sampling the electrical beat signal comprises sampling in parallel the electrical beat signal from a single chirp segment.

13. The method of claim 12, wherein sampling in parallel the electrical beat signal comprises, for each predetermined frequency sampling a duplicate of the electrical beat signal from the single chirp segment with a respective ADC.

14. The method of claim 11, wherein sampling the electrical beat signal comprises serially sampling the electrical beat signal from separate similar chirp segments.

15. The method of claim 14, wherein serially sampling comprises serially sampling with a single ADC multiple similar electrical beat signals from said similar chirp segments one after another, at least one similar chirp segment for each predetermined sampling frequency.

16. The method of claim 11, wherein the predetermined sampling frequencies are selected such that a number of sampling points per sampling time period for each predetermined sampling frequency is a prime number unequal to the number sampling points per sampling time period for every other predetermined sampling frequency.

17. The method of claim 11, wherein the predetermined sampling frequencies are selected such that a number of sampling points per sampling time period for each predetermined sampling frequency is coprime with and unequal to the number sampling points per sampling time period for every other predetermined sampling frequency.

18. The method of claim 11, wherein the predetermined sampling frequencies are selected such that a number of sampling points per sampling time period for each predetermined sampling frequency has a least common multiple with the number of sampling points per sampling time period for every other predetermined sampling frequency, such that the effective measurable beat frequency range spans distance ranges and Doppler velocities of interest.

19. The method of claim 11, wherein disambiguating the at least two measured beat frequencies includes:
shifting each measured beat frequency of the at least two measured beat frequencies by integer multiples of their respective predetermined sampling frequencies generating shifted measured beat frequency values; and
determining when the shifted measured beat frequency values coincide with each other within a selected tolerance, generating said candidate true beat frequency value.

20. The method of claim 19, further comprising generating a first true beat frequency value corresponding to a true beat frequency of an up-chirp segment, generating a second true beat frequency value corresponding to a true beat frequency of a down-chirp segment, and determining a distance range and a Doppler velocity of an object of interest from the first and second true beat frequency values.
